(19) United States
(12) Patent Application Publication
(10) Pub. No.: US 2026/0370341 A1
(43) Pub. Date: Nov. 19, 2026

(54) COHERENT OPTICAL COMPUTING SYSTEM AND METHOD FOR SOLVING ISING PROBLEMS USING ELECTRO-OPTIC COHERENT ISING MACHINE

(71) Applicant: Quanfluence Pvt. Ltd., Bangalore (IN)

(72) Inventors: Biman Chattopadhyay, Bengaluru (IN); Ravi Mehta, Bangalore (IN)

(21) Appl. No.: 19/550,348

(22) Filed: Feb. 26, 2026

(30) Foreign Application Priority Data
May 13, 2025 (IN) 202541046159

(51) Int. Cl. H04B 10/61; H04B 10/63

(52) U.S. Cl. CPC H04B 10/616; H04B 10/614; H04B 10/63

(57) ABSTRACT

Coherent optical computing system and method for solving ising problems using electro-optic CIM are disclosed. Coherent optical computing system includes Multi-Path Interferometer (MPI) that receives optical signals representing dynamic spin variables, configured by coefficient matrix (N×N) modelling Ising problem. MPI executes linear operations for spin and variable interactions. Balanced Homodyne Detectors (BHDs), with beam-splitters, high-bandwidth photodiodes, and Transimpedance Amplifiers, convert optical signals into electrical outputs, updating spin variables. Mach-Zehnder Interferometers (MZIs) non-linearly control optical electric field value at MPI input nodes using BHD outputs. Sampling Capacitors (SCs) network with capacitor pairs and clock signal manages sampling/holding phases for discrete-time spin evolution, converging to high or low spin values. Laser source generates optical signals. Output circuitry delivers spin evolution as Ising problem solution.

### TECHNICAL FIELD

The present disclosure generally relates to Coherent Ising Machines (CIMs) and, more specifically, relates to a coherent optical computing system for solving Ising problems using an electro-optic Coherent Ising Machine (CIM).

### BACKGROUND

Recent advancements in optical and quantum computing are paving the way for new computational paradigms, which may soon replace conventional digital computers in challenging tasks. Further, combinatorial optimization problems are of particular interest, as they are frequently classified as Nondeterministic Polynomial Time (NP)-hard, which may not be efficiently solved using conventional digital computers. Furthermore, to speed up calculation time compared to digital hardware, different unconventional computing architectures have been proposed, which may attempt to solve optimization problems by mapping them to Ising models. Furthermore, finding an optimal solution may become equivalent to finding the ground state of the Ising model. Furthermore, implementation with networks of coupled artificial Ising spins may be realized with various physical systems, for example, superconducting electronics components, trapped ions, and optical states. Moreover, the energy function in Ising machines may often be proportional to that of a conventional Ising Hamiltonian, which may allow the system to naturally evolve toward the ground state of the Ising model, and thereby reach the optimal solution.

Additionally, as the evolution to the ground state typically occurs on very fast timescales, Ising machines promise a considerable speed up over conventional algorithms in finding solutions to optimization problems, which may have significant implications for various important areas such as finance, pharmaceutics, logistics, and machine learning. Also, Coherent Ising machines (CIMs) have recently garnered significant attention among the various emerging concepts. The CIMs use formal similarities between the Ising Hamiltonian and the Hamiltonian of bistable generic term interfering coherent optical states to realize large-scale Ising machines with networks of coupled optical states. Further, this may offer a number of advantages over other Ising machines, such as quantum annealing, as the CIMs may be able to operate at room temperature. Further, the CIMs may be constructed from off-the-shelf photonic components. Furthermore, the CIMs are also capable of implementing arbitrary coupling topologies.

Additionally, the CIMs are also gain-dissipative systems, which may make the CIMs efficient in escaping local energy minima and thus, making the CIMs suitable for solving optimization problems. The optimal solution, then, may represent the lowest loss configuration. Also, the optimal solution may be found by driving the system close to the minimum gain threshold, where other local energy minima may not be stable yet. Further, various types of the CIMs have been anticipated, which may implement Ising spin networks with bistable coherent optical states, such as coupled lasers and degenerate optical parametric oscillators (DOPOs). Further, the current state-of-the-art CIMs based on the DOPOs have demonstrated the ability as global optimizers for various large-scale problems. Also, by taking advantage of the large bandwidth of optical systems, the CIMs based on the DOPOs may operate at high speed. Also, the CIMs based on the DOPOs have shown speed-ups over conventional algorithms.

However, the generation, interference, and detection of the coherent optical states may be phase-sensitive, which may make stable operation technically challenging. Additionally, in the DOPO-based CIMs, artificial Ising spins may be represented by the optical phase of short laser pulses, which may be generated by nonlinear optical processes and circulated inside a kilometer-long ring fiber cavity. Further, phase-stability may be required for the whole length of the cavity, which may make the system highly susceptible to external perturbations, often leading to cases where unstable conditions deteriorate performance. Furthermore, the nonlinear DOPO-based CIMs generation process may demand powerful laser systems and temperature-controlled nonlinear materials, which may result in large and complex optical setups.

Further, FIGS. 1A-1B illustrate an opto-electronic oscillator (OEO)-based coherent Ising machine 100A, PC polarization controller, and analogue to digital converter (ADC), digital to analogue converter (DAC), and working principle 100B during two consecutive iterations, respectively, according to prior art. Moreover, an Ising model may describe an ensemble of binary spins σₙ, which may be at least in a spin-up σₙ=1 and the spin-down state σₙ=−1. Further, interaction of the binary spins σₙ, may be achieved by coupling the binary spins σₙ using a spin coupling topology Jₘₙ. Furthermore, the energy function of an ensemble of N coupled spins may be then given by the Ising Hamiltonian.

$${H}_{Ising} = - \frac{1}{2} {\sum }_{mn}^{N} {J}_{mn} {σ}_{m} {σ}_{n} \qquad ( 1 )$$

Further, the Hamiltonian of interfering optical coherent states may be analogous to the Ising model, where the spin coupling Jₘₙ may correspond to the optical phase difference Δφ and the optical coupling strength of the interfering states. Furthermore, for example, the Ising Hamiltonian may correspond to coupled Degenerate Optical Parametric Oscillators (DOPOs), where the phase difference may be fixed to Δφ={0, π}. Furthermore, due to this phase degeneracy, the electrical field may be real valued with one of a positive and a negative amplitude. Furthermore, if the phase sensitivity may be removed in the electro-optic CIM, which may include an optical and an electrical pathway, as illustrated in FIG. 1A. Furthermore, the optical pathway may implement a nonlinearity by feeding the output of a laser diode) through a Mach-Zehnder modulator (MZM) and detecting it with a photodiode. Furthermore, the electrical pathway may create time-discrete feedback by sampling the photovoltage and feeding a time-discrete feedback back to the input nodes of the MZM. Furthermore, inside the MZM, the coherent input may be split and interfered with inherently. Furthermore, a phase difference corresponding to a feedback signal may be set within one of the arms by a phase modulator, and the one or more output nodes of the MZM may then square the in-phase component of the interfering electrical fields. Furthermore, when compared to DOPO-based CIMs, the output approximates the coherent superposition of DOPO pulses. Furthermore, by coupling the output of multiple optical electric oscillators (OEOs) together, in at least one of electrically and optically, a network of bistable optical states may be generated to represent an ensemble of Ising spins. Furthermore, contrary to DOPO-based CIMs, however, generation, interference, and detection of the optical states may fully be contained within the MZM and the feedback system. Furthermore, all information about the optical states may be encoded in the light intensity outside of the MZM. Therefore, the phase sensitivity may be removed. Furthermore, to map the OEOs network to a network of Ising spins, the nonlinear nature of the opto-electronic feedback system may be exploited. Furthermore, for an ensemble of coupled OEOs with the time-discrete feedback, the time evolution of the nth OEO xₙ[k] during iteration step k is given by the following nonlinear map in equation (2).

$${x}_{n} [ k + 1 ] = {cos}^{2} ( {f}_{n} [ k ] - \frac{π}{4} + {ζ}_{n} [ k ] ) - \frac{1}{2} \qquad ( 2 )$$

Additionally, the Gaussian white noise ξn[k] and a constant bias of −π/4 may be applied. The feedback term fn[k] is calculated according to equation 3 as provided below.

fn[k]=αxₙ[k]+βΣₘJₘₙxₘ[k] (3)

Further, fₙ[k] may include both self-feedback to each oscillator xₙ[k] with the feedback strength α as well as mutual coupling with the coupling matrix Jₘₙ and the coupling strength β. Furthermore, without mutual coupling (β=0) may easily be shown by linear stability analysis, which may undergo a pitchfork bifurcation at α=1. Furthermore, below the bifurcation point, the system has only one stable fixed point

$${x}_{1}^{*} = 0 ,$$

while above the bifurcation point the system has two stable fixed points x₂*_{,3}={−a₀,a₀} and one unstable fixed point

$${x}_{1}^{*} = 0.$$

Furthermore, the pitchfork bifurcation may result in a symmetrical bistability, where there is an equal probability that a single oscillator may end up in one of the two stable fixed points when the system may be initially in the unstable fixed point. Furthermore, Ising spin networks may be then generated by mapping the photovoltage xₙ[k] to the Ising spins σₙ by σₙ=sigₙ (xₙ[k]). Furthermore, when compared to DOPO-based CIMs, such DOPO based CIMs have to implement a kind of bi-stability with a phase-sensitive nonlinear optical amplification process. However, in the electro-optic CIM using the nonlinearity of the MZM may be subjected to self-feedback, which may present a significantly easier and more stable approach to realize large-scale spin networks.

Additionally, in FIG. 1B to facilitate the realization and coupling of the OEOs, a time-multiplexing scheme, which allows to emulate of a large ensemble of oscillators with a single system, may be provided. Furthermore, for a network of N spins, the feedback signal may be divided into ‘N’ equal intervals, where each interval represents a single artificial spin. Furthermore, the feedback signal and the photovoltage may then be represented by piecewise constant functions. Furthermore, the feedback signal and the photovoltage may be generated and read out sequentially. Furthermore, when compared to DOPO-based CIMs, the system may employ a hybrid computing scheme where multiplexing and coupling may be performed by digital hardware while the nonlinear system may be implemented with the optical system. Furthermore, for each iteration, the photovoltage xₙ and the feedback signal fₙ for each spin n are updated in a two-stage process, namely a sampling and a processing stage. Furthermore, in the sampling stage, the multiplexed feedback signal may be injected from a Digital to Analogue Converter (DAC) to the MZM. Furthermore, the resulting photovoltage may be sampled by an Analog-to-Digital Converter (ADC). Furthermore, in the processing stage, the signal may be demultiplexed, a matrix multiplication may be performed to facilitate the spin coupling, and the resulting feedback signal may be multiplexed again for the next iteration. Furthermore, a hybrid computing scheme may present a compromise as the hybrid computing scheme may allow to implementation of arbitrary networks while taking advantage of some of the high bandwidth of the optical system. Furthermore, when compared to the DOPO-based CIMs, the electro-optic CIM may enable fast computation times at rates of hundreds of megahertz per spin, which may already outperform other heuristic methods. However, an all-optical approach could remove any slowdown of the digital I/O system and take full advantage of the optical system to further increase the rate to tens of gigahertz.

Additionally, FIGS. 2A-2B illustrate distribution 200A of the spin amplitude for 100 uncoupled artificial Ising spins after 100 iterations as the feedback strength α is varied, and time evolution 200B of spin amplitude for feedback strengths of α1=0.8 and α2=1.3, and the respective distribution of amplitudes respectively, according to prior art. Further, in FIG. 2A behaviour of the OEO-based CIM may be tested as an artificial spin network by emulating an ensemble of 100 uncoupled spins (Jₘₙ=0). Furthermore, FIG. 2A illustrates an amplitude distribution for all spins after 50 iterations as the feedback strength α may be increased from below to above a bifurcation point. Furthermore, below the bifurcation point, only the trivial fixed point

$${x}_{1}^{*} = 0$$

may be stable and artificial spins may be distributed around

$${x}_{1}^{*} .$$

Furthermore, as the feedback strength increases above α=1, the trivial fixed point becomes unstable and the artificial spins bifurcate into the two new stable fixed points

$${x}_{2 , 3}^{*} = \pm {a}_{0} .$$

Furthermore, as expected for a pitchfork bifurcation, the amplitude do of the stable fixed points may increase with the feedback strength, which may also agree well with simulations of the nonlinear map given in equation 2. Furthermore, for higher feedback strengths, a deviation from the nonlinear map in equation 2 as the spin amplitude may start to saturate due to load limitations of the DAC 506A.

Further, FIG. 2B illustrates time evolution of spin amplitude for feedback strengths of α₁=0.8 and α₂=1.3 and the respective distribution of amplitudes of the coherent optical computing system, according to prior art. Further, FIG. 2B illustrates two exemplary time evolutions for all spins below α=0.8 and above α=1.3 the bifurcation point. Further, at α=0.8, fluctuations of the spins may be observed around the stable fixed point

$${x}_{1}^{*}$$

as a consequence of the noise of the system. Furthermore, at α=1.3, the noise may drive the spins away from the now unstable fixed point

$${x}_{1}^{*}$$

as the spin amplitude bifurcates into the new stable fixed points

$${x}_{2 , 3}^{*} .$$

Furthermore, from the histogram, 49 spins are in the spin up state and 51 spins are in the spin down state, which may exemplify that there may be equal probability for both configurations. Furthermore, for 50 independent measurements, the average probability may be found for the spin up and the spin down configuration are Pᵤₚ=0.49±0.08 and P_{down}=0.51±0.08, thereby corroborating that the artificial spins may be emulating the correct behavior of independent Ising spins.

Additionally, the coherent Ising machine based on the DOPOs may solve combinatorial optimization problems. Further, an integrated circuit implementation of the coherent Ising machine may provide compact size and low energy consumption, suitable for form factors such as edge devices. Furthermore, a space-division multiplexed design gives speed-up by means of parallel operation compared to a time-division multiplexed design. Furthermore, an integrated photonic coherent Ising machine based on self-phase modulation in micro-ring resonators may be presented. Furthermore, an alternate implementation based on photonic and electronic integrated circuits is demonstrated for 64 variables. Furthermore, the power consumption of conversion of analog signal to digital in order to perform digital operation, and subsequent conversion from digital to analog signal in order to control optical modulation are significant contribution to the overall energy dissipation. This is also a speed bottleneck.

Additionally, such drawbacks make the CIMs challenging to build and, operate and also hinder realization as small and cost-efficient devices, for example, photonic integrated circuits. Typically, frustrated lattices may be more challenging to solve due to local energy minima and critical slowing down and thus, present a challenge to conventional solvers such as stochastic simulation methods and Recurrent Neural Networks.

Therefore, there is a need for a coherent optical computing system and method for solving ising problems using an electro-optic Coherent Ising Machine (CIM), which may improve the stability and decrease footprint of the electro-optic CIM, which may be subjected to self-feedback, and thereby eliminating necessity for non-linear optical processes and large external cavities.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a coherent optical computing system for solving Ising problems using an electro-optic Coherent Ising Machine (CIM). The coherent optical computing system includes a Multi-Path Interferometer (MPI). Further, the MPI receives a plurality of optical signals corresponding to a plurality of dynamic spin variables of one or more Ising problems. Furthermore, the MPI is an optical circuit implementing a coefficient matrix including coefficients in N rows and N columns representing an Ising model. Furthermore, each of the dynamic spin variables corresponds to an electric field of the plurality of optical signals. Furthermore, the MPI executes a linear operation corresponding to at least one of each of spin interactions and each of variable interactions in an Ising model, by combining a plurality of dynamic spin variables. Furthermore, the coherent optical computing system includes a plurality of Balanced Homodyne Detectors (BHDs). Furthermore, the plurality of BHDs is communicatively coupled to one or more output nodes of the MPI. Furthermore, each of a plurality of BHDs includes a beam-splitter, a plurality of high-bandwidth photodiodes, and a Transimpedance Amplifier (TIA). Furthermore, the plurality of high-bandwidth photodiodes is configured to measure an optical electric field value of the plurality of optical signals from the beam-splitter and convert it to a difference of electrical current. Furthermore, the TIA is configured to convert the electrical current to an electrical voltage corresponding to an electrical field value of the plurality of optical signals, the plurality of optical signals into electrical output signals, including an updated plurality of dynamic spin variables. Furthermore, the coherent optical computing system includes a plurality of Mach-Zehnder interferometers (MZIs). Furthermore, the plurality of MZIs is communicatively coupled to the one or more input nodes of the MPI. Furthermore, each of the plurality of MZIs is executed by the electrical output signals from a corresponding BHD. Furthermore, each of the plurality of MZIs non-linearly controls an optical electric field value of the corresponding dynamic spin variable at each of the one or more input nodes of the MPI. Furthermore, the coherent optical computing system includes a plurality of Sampling Capacitors (SCs) network associated with each of plurality of BHD. Furthermore, the plurality of SCs network includes at least two pairs of capacitors. Furthermore, in the at least two pairs of capacitors, a first pair of capacitors is configured to sample the electrical output signals of the BHDs, and a second pair of capacitors is configured to hold a previously sampled output, and a clock signal alternates one or more sampling phases and one or more holding phases for discrete-time evolution of the dynamic spin variables. Furthermore, the evolution of the dynamic spin variables includes iteratively updating spin values of the plurality of dynamic spin variables until each spin value converges to at least one of a high spin value and a low spin value. Furthermore, the coherent optical computing system includes a laser source configured to generate the plurality of optical signals. Furthermore, the plurality of optical signals is split by a coupler into at least two sets of 1:N beam-splitter networks. Furthermore, the 1:N beam-splitter networks include a first 1:N beam-splitter network configured to output one or more N optical inputs. Furthermore, each of the one or more N optical inputs are transmitted to a corresponding MZI. Furthermore, the 1:N beam-splitter networks include a second 1:N beam-splitter network configured to output one or more N local oscillator reference signals. Furthermore, each of the one or more N local oscillator reference signals is transmitted to a corresponding BHD. Furthermore, the coherent optical computing system includes an output circuitry configured to output the evolution of the dynamic spin variables comprising a solution to the one or more Ising problems.

In another aspect, the present disclosure relates to a method for solving Ising problems using an electro-optic Coherent Ising Machine (CIM). Further, the method includes receiving, by a system via a Multi-Path Interferometer (MPI), a plurality of optical signals corresponding to a plurality of dynamic spin variables of one or more ising problems. Furthermore, the dynamic spin variables comprise a coefficient matrix comprising coefficients in N rows and N columns. Furthermore, the method includes executing, by the system via the MPI, a linear operation corresponding to at least one of each spin interactions and each of variable interactions in an Ising model, by combining a plurality of dynamic spin variables comprising the coefficient matrix with a coupling matrix. Furthermore, each of the dynamic spin variable corresponds to an electric field of the plurality of optical signals. Furthermore, the method includes measuring, by the system via a high-bandwidth photodiode associated with a plurality of Balanced Homodyne Detectors (BHDs), the electric field of the plurality of optical signals. Furthermore, the method includes converting, by the system via a Transimpedance Amplifier (TIA) associated with the plurality of BHDs, the plurality of optical signals into electrical output signals comprising an updated plurality of dynamic spin variables. Furthermore, the method includes executing, by the system via a plurality of Mach-Zehnder interferometers (MZIs), the plurality of MZIs using the electrical output signals from a corresponding BHD and controlling non-linearly an intensity of the corresponding dynamic spin variable at each of the MPI. Furthermore, the method includes holding, by the system via a plurality of Sampling Capacitors (SCs) network, a previously sampled output, and alternating, using a clock signal, one or more sampling phases and one or more holding phases for discrete-time evolution of the dynamic spin variables. Furthermore, the evolution of the dynamic spin variables comprises iteratively updating spin values of the plurality of dynamic spin variables until each spin value converges to at least one of a high spin value and a low spin value. Furthermore, the method includes generating, by the system via a laser source, the plurality of optical signals. Furthermore, the plurality of optical signals is split by a coupler, into at least two sets of 1:N beam-splitter networks. Furthermore, the method includes outputting, by the system via an output circuitry, the evolution of the dynamic spin variables comprising a solution to the one or more ising problems.

To further clarify the features of the present disclosure, a more particular description of the disclosure may follow by reference to specific embodiments thereof, which may be illustrated in the appended figures. One may appreciate that these figures depict typical embodiments of the disclosure and may therefore not to be considered limiting in scope. The disclosure may be described and explained with additional specificity and detail with the appended figures.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale; emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components, or circuitry commonly used to implement such components.

FIGS. 1A-1B illustrate an opto-electronic oscillators (OEO)-based coherent Ising machine, PC polarization controller, and analogue to digital converter (ADC), digital to analogue converter (DAC), and working principle during two consecutive iterations, respectively, according to prior art;

FIGS. 2A-2B illustrate distribution of the spin amplitude for 100 uncoupled artificial Ising spins after 100 iterations as the feedback strength α is varied and time evolution of spin amplitude for feedback strengths of α₁=0.8 and α₂=1.3, and the respective distribution of amplitudes respectively, according to prior art;

FIG. 3 illustrates an exemplary block diagram representation of a coherent optical computing system for solving Ising problems using an electro-optic Coherent Ising Machine (CIM), according to embodiments of the present disclosure;

FIG. 4 illustrates an exemplary block diagram representation of the coherent optical computing system, such as those shown in FIG. 3, for solving Ising problems using the electro-optic Coherent Ising Machine (CIM), according to embodiments of the present disclosure;

FIG. 5 illustrates an exemplary flow diagram representation depicting working of a multi-path interferometer (MPI) of the coherent optical computing system, according to embodiments of the present disclosure;

FIG. 6 illustrates an exemplary flow diagram representation depicting a sample-and-hold switched capacitor network to realize discrete time operation, according to embodiments of the present disclosure; and

FIG. 7 illustrates an exemplary flow chart depicting an example method for solving Ising problems using an electro-optic Coherent Ising Machine (CIM), according to embodiments of the present disclosure.

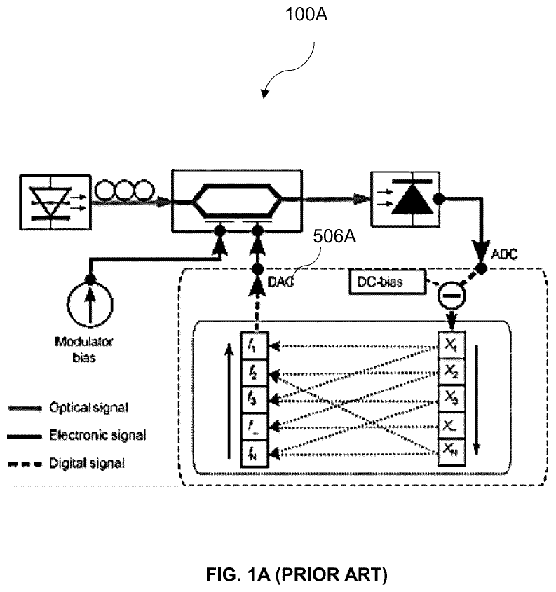

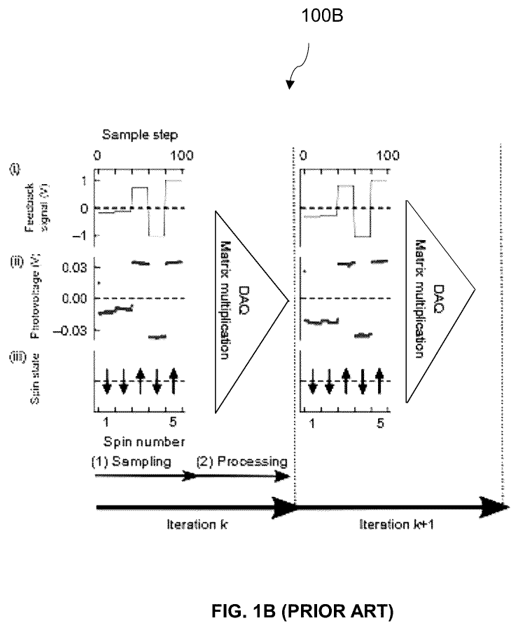

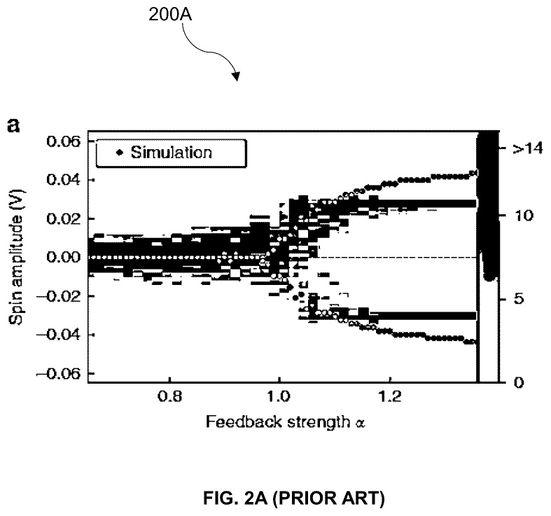

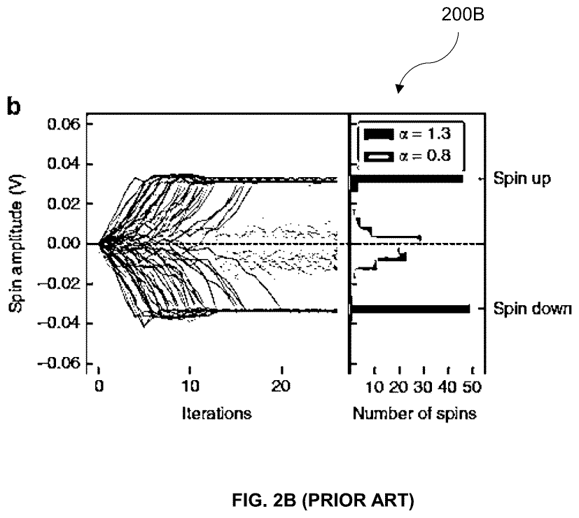

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above, or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Examples of the present disclosure provide a system and method for solving Ising problems using an electro-optic Coherent Ising Machine (CIM). The coherent optical computing system includes a Multi-Path Interferometer (MPI). Further, the MPI receives a plurality of optical signals corresponding to a plurality of dynamic spin variables of one or more Ising problems. Furthermore, the MPI is an optical circuit implementing a coefficient matrix including coefficients in N rows and N columns representing an Ising model. Furthermore, each of the dynamic spin variables corresponds to an electric field of a plurality of optical signals. Furthermore, the MPI executes a linear operation corresponding to at least one of each of spin interactions and each of variable interactions in an Ising model, by combining a plurality of dynamic spin variables. Furthermore, the coherent optical computing system includes a plurality of Balanced Homodyne Detectors (BHDs). Furthermore, the plurality of BHDs is communicatively coupled to one or more output nodes of the MPI. Furthermore, each of a plurality of BHDs includes a beam-splitter, a plurality of high-bandwidth photodiodes, and a Transimpedance Amplifier (TIA). Furthermore, the plurality of high-bandwidth photodiodes is configured to measure an optical electric field value of the plurality of optical signals from the beam-splitter and convert it to a difference of electrical current. Furthermore, the TIA is configured to convert the electrical current to an electrical voltage corresponding to an electrical field value of the plurality of optical signals, the plurality of optical signals into electrical output signals including an updated plurality of dynamic spin variables. Furthermore, the coherent optical computing system includes a plurality of Mach-Zehnder interferometers (MZIs). Furthermore, the plurality of MZIs is communicatively coupled to the one or more input nodes of the MPI. Furthermore, each of the plurality of MZIs is executed by the electrical output signals from a corresponding BHD. Furthermore, each of the plurality of MZIs non-linearly controls an optical electric field value of the corresponding dynamic spin variable at each of the one or more input nodes of the MPI. Furthermore, the coherent optical computing system includes a plurality of Sampling Capacitors (SCs) network associated with each of plurality of BHD. Furthermore, the plurality of SCs network includes at least two pairs of capacitors. Furthermore, in the at least two pairs of capacitors, a first pair of capacitors is configured to sample the electrical output signals of the BHDs, and a second pair of capacitors is configured to hold a previously sampled output, and a clock signal alternates one or more sampling phases and one or more holding phases for discrete-time evolution of the dynamic spin variables. Furthermore, the evolution of the dynamic spin variables includes iteratively updating spin values of the plurality of dynamic spin variables until each spin value converges to at least one of a high spin value and a low spin value. Furthermore, the coherent optical computing system includes a laser source configured to generate a plurality of optical signals. Furthermore, the plurality of optical signals is split by a coupler, into at least two sets of 1:N beam-splitter networks. Furthermore, the 1:N beam-splitter networks include a first 1:N beam-splitter network configured to output one or more N optical inputs. Furthermore, each of the one or more N optical inputs is transmitted to a corresponding MZI. Furthermore, the 1:N beam-splitter networks include a second 1:N beam-splitter network configured to output one or more N local oscillator reference signals. Furthermore, each of the one or more N local oscillator reference signals is transmitted to a corresponding BHD. Furthermore, the coherent optical computing system includes an output circuitry configured to output the evolution of the dynamic spin variables comprising a solution to the one or more Ising problems.

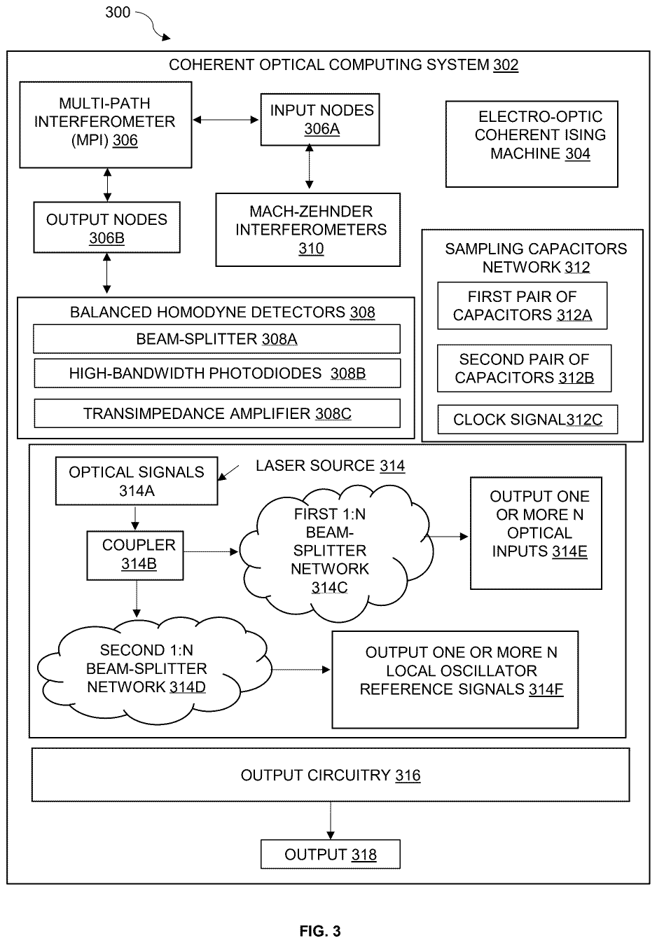

Referring now to the drawings, and more particularly to FIG. 3 through FIG. 7, where similar reference characters denote corresponding features consistently throughout the figures, there are shown preferred embodiments, and these embodiments are described in the context of the following exemplary system and/or method.

FIG. 3 illustrates an exemplary block diagram 300 representation of the coherent optical computing system 302 for solving Ising problems using the electro-optic Coherent Ising Machine (CIM) 304, according to embodiments of the present disclosure. Further, the coherent optical computing system 302 includes a Multi-Path Interferometer (MPI) 306. Furthermore, the MPI 306 is configured to receive a plurality of optical signals corresponding to a plurality of dynamic spin variables of one or more Ising problems. Furthermore, the MPI 306 is configured based on a coefficient matrix including coefficients in N rows and N columns representing an Ising model. Furthermore, each of the dynamic spin variables corresponds to an electric field of the plurality of optical signals. Furthermore, the MPI 306 is configured to execute a linear operation corresponding to at least one of each of spin interactions and each of variable interactions in an Ising model, by combining a plurality of dynamic spin variables. Furthermore, a plurality of Balanced Homodyne Detectors (BHDs) 308 communicatively coupled to one or more output nodes 306B of the MPI 306. Furthermore, each of plurality of BHDs 308 includes a beam-splitter 308A, a plurality of high-bandwidth photodiodes 308B configured to measure an optical electric field value of the plurality of optical signals from the beam-splitter 308A and convert to a difference of electrical current. Furthermore, each of plurality of BHDs 308 includes a Transimpedance Amplifier (TIA) 308C, which is configured to convert the electrical current to an electrical voltage corresponding to an electrical field value of the plurality of optical signals, plurality of optical signals into electrical output signals including an updated plurality of dynamic spin variables. Furthermore, a plurality of Mach-Zehnder interferometers (MZIs) 310 are communicatively coupled to the one or more input nodes 306A of the MPI 306. Furthermore, each of the plurality of MZIs 310 is executed by the electrical output signals from a corresponding BHD 308, and non-linearly control an optical electric field value of the corresponding dynamic spin variable at each of the one or more input nodes 306A of the MPI 306. Furthermore, a plurality of Sampling Capacitors (SCs) network 312 is associated with each of plurality of BHDs 308, the plurality of SCs network 312 including at least two pairs of capacitors. Furthermore, in the at least two pairs of capacitors, a first pair of capacitors 312A is configured to sample the electrical output signals of the BHDs 308, and a second pair of capacitors 312B is configured to hold a previously sampled output, and a clock signal 312C alternates one or more sampling phases and one or more holding phases for discrete-time evolution of the dynamic spin variables. Furthermore, the evolution of the dynamic spin variables includes iteratively updating spin values of a plurality of dynamic spin variables until each spin value converges to at least one of a high spin value and a low spin value. Furthermore, a laser source 314 is configured to generate the plurality of optical signals 314A, wherein the plurality of optical signals 314A are split by a coupler 314B, into at least two sets of 1:N beam-splitter networks. Furthermore, the 1:N beam-splitter networks include a first 1:N beam-splitter network 314C configured to output one or more N optical inputs. Furthermore, each of the one or more N optical inputs 314E are transmitted to a corresponding MZI 310. Furthermore, the 1:N beam-splitter networks include a second 1:N beam-splitter network 314D configured to output one or more N local oscillator reference signals 314F. Furthermore, each of the one or more N local oscillator reference signals 314F are transmitted to a corresponding BHD 308. Furthermore, an output circuitry 316 is configured to output 318 the evolution of the dynamic spin variables comprising a solution to the one or more ising problems.

In an exemplary embodiment, the MPI 306 may be defined as an optical device used to split a wave, usually light into multiple paths, allow each path to undergo different phase shifts and delays, and then recombine different phase shifts and delays to produce interference patterns. Further, such patterns may reveal detailed information about the properties of the waves and the media the wave pass through.

In an exemplary embodiment, the electro-optic Coherent Ising Machine (CIM) 304 may be defined as a type of optical computing device, which may be designed to solve complex optimization problems by mimicking the behavior of spins in an Ising model, using light such as optical pulses and electro-optic feedback systems. Further, the electro-optic CIM 304 may use optical parametric oscillators (OPOs) to represent spins and couples the OPOs using an electronic feedback loop, forming an analog system, which may naturally evolve toward a minimum-energy state of the Ising model, which may effectively solve the optimization problem.

In another exemplary embodiment, the plurality of BHDs 308 may be defined as an interferometric detector setup where a weak signal beam may be mixed with a strong local oscillator (LO) beam on a beam splitter, and the outputs may be detected by at least two photodiodes. Further, the difference in photocurrents may give information about the quadrature components of the signal.

In another exemplary embodiment, the plurality of MZIs 310 may be defined as an optical device, which may split a light beam into two separate paths using a beam splitter. Further, the beam splitter may introduce a phase shift and delay in one or more paths. Furthermore, the light beam may be recombined using another beam splitter. The resulting interference pattern may provide information about phase differences between the paths.

In another exemplary embodiment, the plurality of SCs network 312 may be defined as a configuration of capacitors and electronic switches usually MOSFETs, which may enable sampling of analogue signals. Further, the plurality of SCs network 312 may perform operations such as but not limited to integration, subtraction, addition, and filtering by controlling how charge is transferred between capacitors.

In another exemplary embodiment, the laser source 314 may be defined as a device, which generates a beam of coherent, monochromatic, and highly directional light through the process of light amplification by stimulated emission of radiation.

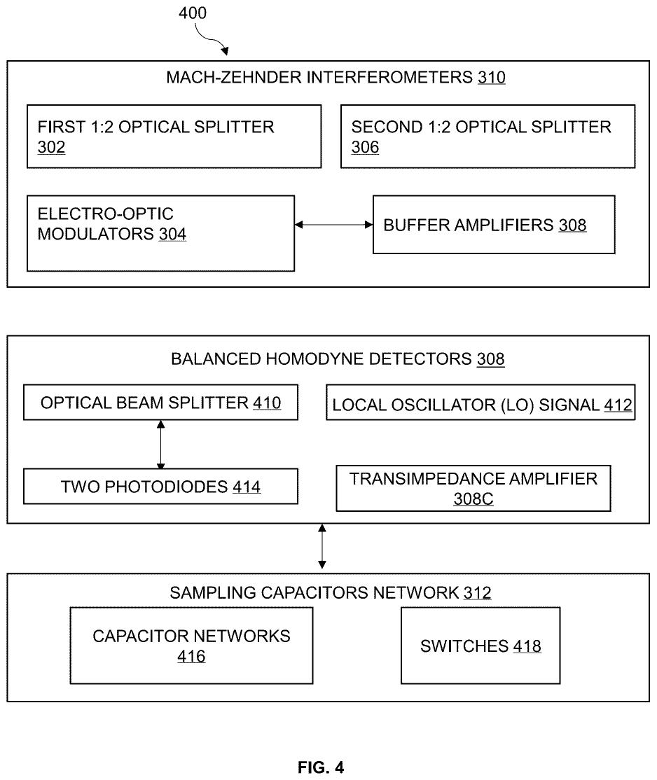

FIG. 4 illustrates an exemplary block diagram 400 representation of the coherent optical computing system 302, such as those shown in FIG. 3, for solving Ising problems using the electro-optic Coherent Ising Machine (CIM) 304, according to embodiments of the present disclosure. Further, the coherent optical computing system 302 includes the plurality of MZIs 310. Furthermore, the plurality of MZIs 310 includes a first 1:2 optical splitter 402 is configured to divide the plurality of optical signals into at least two optical paths. Furthermore, the plurality of MZIs 310 includes at least two Electro-Optic Modulators (EOMs) 404 positioned along the at least two optical paths, which is configured to modulate a phase of the divided plurality of optical signals, based on an external electrical input. Furthermore, the plurality of MZIs 310 includes a second 1:2 optical splitter 406 configured to combine the modulated plurality of optical signals and generate a modulated optical output signal. Furthermore, the plurality of MZIs 310 includes a plurality of buffer amplifiers 408 communicatively coupled to each of the at least two EOMs 404, configured to receive and amplify the modulated optical output signal. Furthermore, the plurality of BHDs 308 includes an optical beam splitter 410 configured to receive the modulated optical output signal and a local oscillator (LO) signal 412 corresponding to the local oscillator reference signals. Furthermore, the optical beam splitter 410 is configured to generate a first optical output signal and a second optical output signal. Furthermore, the plurality of BHDs 308 includes at least two photodiodes 414 coupled to the optical beam splitter, 410 which is configured to convert the optical signals into electric current signals. Furthermore, the plurality of BHDs 308 includes the TIA 308C, which is configured to convert the difference in electric current signals from the at least two photodiodes 414 into voltage signals comprising an electronic voltage signal corresponding to the dynamic spin variables. Furthermore, the plurality of SCs 312 coupled to the plurality of BHDs 308. Furthermore, the plurality of SCs 312 includes a plurality of capacitor networks 416, which is configured to segregate and filter the electric current signals into at least one of a hold signal and a sampling signal. Furthermore, the plurality of SCs 312 includes a plurality of switches 418, which are configured to control a charging and a discharging of the plurality of capacitor networks 416 for sampling and holding the electric current signals into at least one of the hold signal and the sampling signal.

In an exemplary embodiment, each of the plurality of MZI 310 is configured to receive the electrical output signals from the plurality of BHDs 308. Further, each of the MZI 310 is configured to execute a non-linear operation on the electrical output signals to modulate an optical field of the dynamic spin variables at the one or more input nodes 306A of the MPI 306.

In another exemplary embodiment, the MPI 306 is configured to perform a parallel matrix-vector multiplication with an interaction matrix to compute a weighted addition of the spin interactions.

In yet another exemplary embodiment, the one or more ising problems comprise at least one of an optimization problem, a graph problem, and a combinatorial optimization problem.

In yet another exemplary embodiment, the electric field of the plurality of optical signals is modulated based on a periodic sinusoidal transfer function implemented by electrical-to-optical transfer characteristics of the plurality of MZIs 310 and imparting a sinusoidal non-linearity to an optical field of the dynamic spin variables.

In yet another exemplary embodiment, the iteratively updating the spin values of the plurality of dynamic spin variables is based on a gain-dissipative dynamic technique. Further, the plurality of MZIs 310 uses a coupling term to generate an Ising Hamiltonian computation. Furthermore, the coupling term controls the interaction strength between the dynamic spin variables, uses a bifurcation parameter controlling the gain-dissipative dynamics of the system 302. Furthermore, the bifurcation parameter governs a convergence behaviour of the system 302.

In yet another exemplary embodiment, the TIA 308C is configured to generate a differential output for a subsequent sampling through a sampling capacitor network and control of the plurality of optical signals.

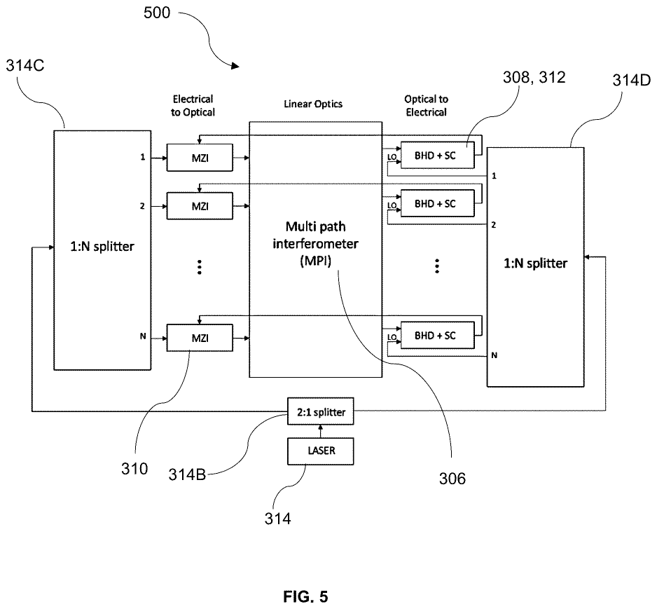

FIG. 5 illustrates an exemplary flow diagram 500 representation depicting working of the multi-path interferometer (MPI) 306 of the coherent optical computing system 302, according to embodiments of the present disclosure. Further, the electro-optic Coherent Ising Machine (CIM) 304 may utilize an all-optical multiplier in the form of the MPI 306. Furthermore, the all-optical multiplier may be used to implement interactions between at least one of different spins and variables in the Ising problem. Furthermore, the plurality of BHDs 308 may be made with the plurality of high bandwidth photodiodes 308B and the TIA 308C. Furthermore, the plurality of BHDs 308 may drive the plurality of MZIs 310 to non-linearly control the intensity of at least one of each variable and spin at the one or more input nodes 306A of the MPI 306. Furthermore, the plurality of SCs network 312 may be used to store analog values. Furthermore, the plurality of SCs network 312 sequence the operations based on the clock signal 312C. Furthermore, the coherent optical computing system 302 may implement a gain dissipative dynamic system described by the equation (a) and (b) mentioned below, which may evolve in discrete time steps [k].

fₙ[k]=αxₙ[k]+βΣₘJₘₙxₘ[k] (a)

xₙ₊₁[k+1]=sin(fₙ[k]) (b)

Additionally, each dynamic spin variable xₙ[k] may be represented by electric field of a light mode instead of light intensity. Further, the Ising Hamiltonian may be expressed through J and applied through a coupling term β. Furthermore, the bifurcation may be controlled by hyperparameter α. Furthermore, the linear operation (1) as illustrated in FIG. 5 may be implemented in photonics through the MPI 306, which may be a coefficient matrix including coefficients in N rows and N columns representing an Ising model. Furthermore, the non-linear operation (2) as illustrated in FIG. 5 may be implemented spatially per dynamic spin variable in a modular slice-based architecture. Furthermore, top-level blocks may include the laser source 314, which may split the plurality of optical signals 314A by the coupler 314B in a ratio of 50:50, thereby driving two sets of 1:N beam-splitter networks. Furthermore, the first 1:N beam-splitter network 314C may provide N inputs, one for each slice of input of the plurality of MZIs 310. Furthermore, the second 1:N beam splitter network 314D may provide N local-oscillator reference signals 314F, one for each slice output BHD 308. Furthermore, photonics part of circuit may be implemented in one chip while the electronics may be implemented in another chip. Furthermore, both the photonic and the electronic chips may be co-packaged along with the laser source 314. Furthermore, the critical speed-determining active circuit may be the TIA 308C of the plurality of BHDs 308. Furthermore, the feasibility of the plurality of high-bandwidth photodiodes 308B may be studied and the TIA 308C with a 20 GigaHertz (GHz) Bandwidth (BW) may be designed. Furthermore, the use of a sampled-analogue loop may address the speed bottleneck of the conventional electro-optical implementation of Ising machines.

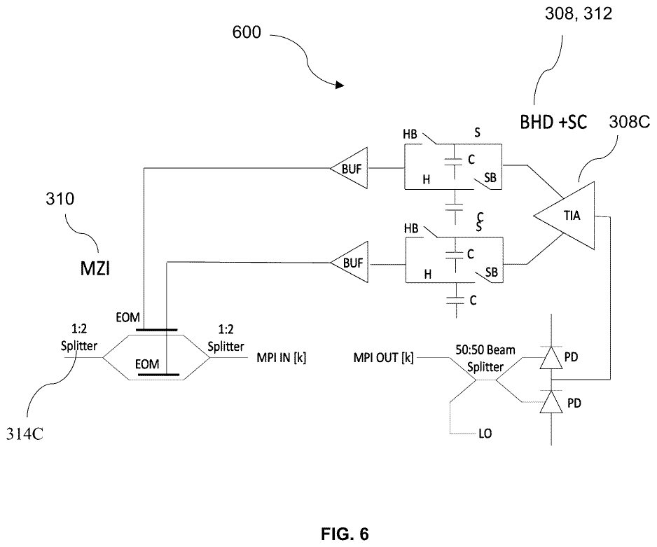

FIG. 6 illustrates an exemplary flow diagram 600 representation depicting the plurality of Sampling Capacitors (SCs) network 312 (interchangeably referred to as a sample-and-hold switched capacitor network 312) to realize discrete time operation, according to embodiments of the present disclosure. Further, each slice consists of the corresponding BHD 308 to measure the electric field of light mode, which may be followed by the sample-and-hold switched capacitor network 312 to realize discrete time operation. Furthermore, the first pair of capacitors 312A may be configured sample the electrical output signals of the BHDs 308. Furthermore, the second pair of capacitors 312B may be configured to hold a previously sampled output. Furthermore, the clock signal 312C may alternates one or more sampling phases and one or more holding phases for discrete-time evolution of the dynamic spin variables. Furthermore, held value may be a differential control of the plurality of MZIs 310. Furthermore, transfer function from the plurality of MZIs 310 may control voltage to output electric field of pulse, which may impart a periodic function nonlinearity such as a sinusoidal function. Furthermore, shot noise of the plurality of BHDs 308 may add random noise.

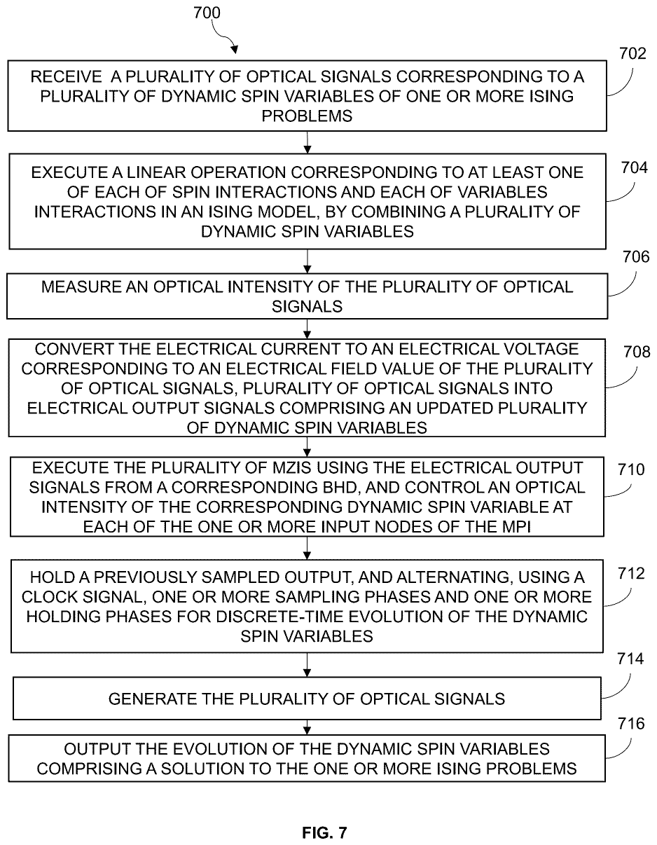

FIG. 7 illustrates an exemplary flow chart 700 depicting an example method for solving Ising problems using an electro-optic Coherent Ising Machine (CIM) 304, according to embodiments of the present disclosure.

At block 702, the method 700 may include receiving, by a system 302 via a Multi-Path Interferometer (MPI) 306, a plurality of optical signals corresponding to a plurality of dynamic spin variables of one or more ising problems, wherein the dynamic spin variables comprise a coefficient matrix comprising coefficients in N rows and N columns.

At block 704, the method 700 may include executing, by the system 302 via the MPI 306, a linear operation corresponding to at least one of each of spin interactions and each of variables interactions in an ising model, by combining a plurality of dynamic spin variables comprising the coefficient matrix with a coupling matrix, wherein each of the dynamic spin variable corresponds to an electric field of the plurality of optical signals.

At block 706, the method 700 may include measuring, by the system 302 via a high-bandwidth photodiode 308B associated with a plurality of Balanced Homodyne Detectors (BHDs) 308, the electric field of the plurality of optical signals.

At block 708, the method 700 may include converting, by the system 302 via a Transimpedance Amplifier (TIA) 308C associated with the plurality of BHDs 308, the plurality of optical signals into electrical output signals comprising an updated plurality of dynamic spin variables.

At block 710, the method 700 may include executing, by the system 302 via a plurality of Mach-Zehnder interferometers (MZIs) 310, the plurality of MZIs 310 using the electrical output signals from a corresponding BHD 308, and controlling non-linearly an intensity of the corresponding dynamic spin variable at each of the MPI 306.

At block 712, the method 700 may include holding, by the system 302 via a plurality of Sampling Capacitors (SCs) network 312, a previously sampled output, and alternating, using a clock signal 312C, one or more sampling phases and one or more holding phases for discrete-time evolution of the dynamic spin variables. Further, the evolution of the dynamic spin variables includes iteratively updating spin values of the plurality of dynamic spin variables until each spin value converges to at least one of a high spin value and a low spin value.

At block 714, the method 700 may include generating, by the system 302 via a laser source 314, the plurality of optical signals 314A. Further, the plurality of optical signals 314A are split by a coupler 314B, into at least two sets of 1:N beam-splitter networks.

At block 716, the method 700 may include outputting, by the system 302 via an output circuitry 316, the evolution of the dynamic spin variables comprising a solution to the one or more Ising problems.

In an example, the method 700 may include dividing, by the system 302 via the plurality of MZIs 310, the plurality of optical signals into at least two optical paths. Further, the method 700 may include modulating, by the system 302 via at least two Electro-Optic Modulators (EOMs) 404, a phase of the divided plurality of optical signals, based on an external electrical input. Furthermore, the method 700 may include combining, by the system 302 via the plurality of MZIs 310, the modulated plurality of optical signals, and generating a modulated optical output signal.

In an example, the method 700 may include, receiving and amplifying, by the system 302 via a plurality of buffer amplifiers 408, the modulated optical output signal. Further, the method 700 may include receiving, by the system 302 via the plurality of BHDs 308, the modulated optical output signal and a local oscillator (LO) signal 412 corresponding to the local oscillator reference signals. Furthermore, the N: N optical beam splitter is configured to generate a first optical output signal and a second optical output signal. Furthermore, the method 700 may include converting, by the system 302 via at least two photodiodes 414, the optical signals into electric current signals. Furthermore, the method 700 may include converting, by the system 302 via the TIA 308C, the difference in electric current signals from the at least two photodiodes 414 into voltage signals comprising discrete-time evolution of the dynamic spin variables. Furthermore, the method 700 may include segregating and filtering, by the system 302 via a plurality of capacitor networks 416, the electric current signals into at least one of a Hard Bit (HB) signal and a Soft Bit (SB) signal corresponding to at least one of the high spin value and the low spin value. Furthermore, the method 700 may include controlling, by the system 302 via a plurality of switches 418, a charging and a discharging of the plurality of capacitor networks 416 for sampling and holding the electric current signals into at least one of the HB signal and the SB signal.

In an exemplary embodiment, the method 700 may include generating, by the system 302 via the TIA 308C, a differential output for a subsequent digital demodulation of the plurality of optical signals 314A.

In an exemplary embodiment, the method 700 may include receiving, by the system 302 via each of the plurality of MZIs 310, the electrical output signals from the plurality of BHDs 308. Further, the method 700 may include executing, by the system 302 via each of the MZI 310, a non-linear operation on the electrical output signals to modulate an optical electric field value of the dynamic spin variables at the one or more input nodes 306A of the MPI 306.

In an exemplary embodiment, the method 700 may include performing, by the system 302 via the MPI 306, a parallel matrix-vector multiplication with an interaction matrix to compute a weighted addition of the spin interactions.

In an exemplary embodiment, the method 700 may include outputting, by the system 302 via a first 1:N beam-splitter network of the laser source 314, the one or more N optical inputs 314E. Further, each of the one or more N optical inputs is transmitted to a corresponding MZI 310. Furthermore, the method 700 may include outputting, by the system 302 via a second 1:N beam-splitter network of the laser source 314, one or more N local oscillator reference signals 314F. Furthermore, each of the one or more N local oscillator reference signals 314F is transmitted to a corresponding BHD 308.

In an example, the one or more ising problems comprise at least one of an optimization problem, a graph problem, and a combinatorial optimization problem.

In an exemplary embodiment, the electric field of the plurality of optical signals 314A is modulated based on a periodic sinusoidal transfer function implemented by electrical-to-optical transfer characteristics of the plurality of MZIs 310 and imparts a sinusoidal non-linearity to an optical electric field value of the dynamic spin variables.

In an exemplary embodiment, the iteratively updating the spin values of the plurality of dynamic spin variables is based on a gain-dissipative dynamic technique. Further, the plurality of MZIs 310 uses a coupling term to generate an Ising Hamiltonian computation. Furthermore, the coupling term controls the interaction strength between the dynamic spin variables, uses a bifurcation parameter controlling the gain-dissipative dynamics of the system 302. Furthermore, the bifurcation parameter governs a convergence behaviour of the system 302.

The present disclosure provides a system and method for solving Ising problems using the electro-optic Coherent Ising Machine (CIM). Further, the present system may improve the stability and decrease the footprint of the electro-optic CIM by implementing a CIM based on opto-electronic oscillators (OEOs) subjected to self-feedback. Furthermore, the OEOs may be an attractive choice since the OEOs may be easily built from a few off-the-shelf components and as photonic integrated circuits. Furthermore, the OEOs are known for inherent stability and complex nonlinear dynamics, which may be used in various applications, such as but not limited to cryptography, microwave generation, and optical neuronal computing. Furthermore, the present system demonstrates that the rich bifurcation structure of the OEOs may be used to generate arbitrarily large controllable artificial spin networks. Furthermore, the OEOs may be compact experimental setup, which may require only a few components. Furthermore, performance in solving optimization problems with up to 100 spins may be tested. Furthermore, the present system may be suitable as a solver for MAXCUT optimization problems with similar and better performance compared to DOPO-based CIMs. Furthermore, contrary to DOPO-based CIMs, the present system may not require external cavities and nonlinear optical processes, which drastically decreases cost and footprint, while also enhancing stability of the present system. Furthermore, this may demonstrate the large potential of feedback systems in general to be used for the computation of the Ising model.

Additionally, the present system may avoid the use of analog-to-digital converters (ADC) and digital-to-analog converters (DAC) and thereby saves on power and latency introduced by such components. Further, the use of optics and analog components may give low power and high-speed operations. Furthermore, an FPGA may be used by some implementations, which may be slow and power-hungry. Furthermore, the present system may not require an FPGA.

The present systems and methods may provide Coherent Ising machines (CIMs), which may constitute a promising approach to solve computationally hard optimization problems by mapping them to ground state searches of the Ising model and implementing them with optical artificial spin-networks. However, while CIMs promise speed-ups over conventional digital computers, they are still challenging to build and operate. Further, the present system may propose and test a concept for a fully programmable CIM, which may be based on optoelectronic oscillators subjected to self-feedback. Furthermore, contrary to current CIM designs, the artificial spins may be generated in feedback induced bifurcation and encoded in the intensity of coherent states. Furthermore, the necessity for nonlinear optical processes and large external cavities may be removed. Furthermore, the present system may offer significant advantages regarding stability, size, and cost. Furthermore, a compact setup for solving MAXCUT optimization problems may be demonstrated on regular and frustrated graphs with 100 spins. Furthermore, the present system may report better performance compared to CIMs based on degenerate optical parametric oscillators (DOPOs).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include, but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A coherent optical computing system for solving Ising problems using an electro-optic Coherent Ising Machine (CIM), the coherent optical computing system comprising:
a Multi-Path Interferometer (MPI) configured to:
receive a plurality of optical signals corresponding to a plurality of dynamic spin variables of one or more ising problems, wherein the MPI is configured based a coefficient matrix comprising coefficients in N rows and N columns representing an ising model, and wherein each of the dynamic spin variables corresponds to an electric field of the plurality of optical signals; and
execute a linear operation corresponding to at least one of each of spin interactions and each of variables interactions in an Ising model, by combining a plurality of dynamic spin variables;
a plurality of Balanced Homodyne Detectors (BHDs) communicatively coupled to one or more output nodes of the MPI, wherein each of plurality of BHDs comprises a beam-splitter, a plurality of high-bandwidth photodiodes configured to measure an optical electric field value of the plurality of optical signals from the beam-splitter and convert to a difference of electrical current, and a Transimpedance Amplifier (TIA) configured to convert the electrical current to an electrical voltage corresponding to an electrical field value of the plurality of optical signals, plurality of optical signals into electrical output signals comprising an updated plurality of dynamic spin variables;
a plurality of Mach-Zehnder interferometers (MZIs) communicatively coupled to the one or more input nodes of the MPI, wherein each of the plurality of MZIs is executed by the electrical output signals from a corresponding BHD, and non-linearly controls an optical electric field value of the corresponding dynamic spin variable at each of the one or more input nodes of the MPI;
a plurality of Sampling Capacitors (SCs) network associated with each of plurality of BHDs, the plurality of SCs network comprising at least two pairs of capacitors, wherein in the at least two pairs of capacitors, a first pair of capacitors is configured to sample the electrical output signals of the BHDs, and a second pair of capacitors is configured to hold a previously sampled output, and a clock signal alternates one or more sampling phases and one or more holding phases for discrete-time evolution of the dynamic spin variables, wherein the evolution of the dynamic spin variables comprises iteratively updating spin values of the plurality of dynamic spin variables until each spin value converges to at least one of a high spin value and a low spin value;
a laser source configured to generate the plurality of optical signals, wherein the plurality of optical signals are split by a coupler, into at least two sets of 1:N beam-splitter networks, wherein the 1:N beam-splitter networks comprise:
a first 1:N beam-splitter network configured to output one or more N optical inputs, wherein each of the one or more N optical inputs is transmitted to a corresponding MZI; and
a second 1:N beam-splitter network configured to output one or more N local oscillator reference signals, wherein each of the one or more N local oscillator reference signals is transmitted to a corresponding BHD; and
an output circuitry configured to output the evolution of the dynamic spin variables comprising a solution to the one or more Ising problems.

2. The coherent optical computing system as claimed in claim 1, further comprises:
the plurality of MZIs comprising:
a first 1:2 optical splitter configured to divide the plurality of optical signals into at least two optical paths;
at least two Electro-Optic Modulators (EOMs) positioned along the at least two optical paths, configured to modulate a phase of the divided plurality of optical signals, based on an external electrical input;
a second 1:2 optical splitter configured to combine the modulated plurality of optical signals, and generate a modulated optical output signal;
a plurality of buffer amplifiers communicatively coupled to each of the at least two EOMs, configured to receive and amplify the modulated optical output signal;
the plurality of BHDs comprising:
an optical beam splitter configured to receive the modulated optical output signal and a local oscillator (LO) signal corresponding to the local oscillator reference signals, wherein the optical beam splitter is configured to generate a first optical output signal and a second optical output signal;
at least two photodiodes coupled to the optical beam splitter, configured to convert the optical signals into electric current signals;
the TIA configured to convert the difference in electric current signals from the at least two photodiodes into voltage signals comprising an electronic voltage signal corresponding to the dynamic spin variables;
the plurality of SCs coupled to the plurality of BHDs, the plurality of SCs comprises:
a plurality of capacitor networks configured to segregate and filter the electric current signals into at least one of a hold signal and a sampling signal; and
a plurality of switches configured to control a charging and a discharging of the plurality of capacitor networks for sampling and holding the electric current signals into at least one of the hold signal and the sampling signal.

3. The coherent optical computing system as claimed in claim 1, wherein each of the MZI is configured to:
receive the electrical output signals from the plurality of BHDs, and
execute a non-linear operation on the electrical output signals to modulate an optical field of the dynamic spin variables at the one or more input nodes of the MPI.

4. The coherent optical computing system as claimed in claim 1, wherein the MPI is configured to perform a parallel matrix-vector multiplication with an interaction matrix to compute a weighted addition of the spin interactions.

5. The coherent optical computing system as claimed in claim 1, wherein the one or more ising problems comprise at least one of an optimization problem, a graph problem, and a combinatorial optimization problem.

6. The coherent optical computing system as claimed in claim 1, wherein the electric field of the plurality of optical signals is modulated based on a periodic sinusoidal transfer function implemented by electrical-to-optical transfer characteristics of the plurality of MZIs and imparting a sinusoidal non-linearity to an optical field of the dynamic spin variables.

7. The coherent optical computing system as claimed in claim 1, wherein the iteratively updating the spin values of the plurality of dynamic spin variables is based on a gain-dissipative dynamic technique, wherein the plurality of MZIs uses a coupling term to generate an ising Hamiltonian computation, wherein the coupling term controls the interaction strength between the dynamic spin variables, uses a bifurcation parameter controlling the gain-dissipative dynamics of the system, wherein the bifurcation parameter governs a convergence behaviour of the system.

8. The coherent optical computing system as claimed in claim 2, wherein the TIA is configured to generate a differential output for a subsequent sampling through a sampling capacitor network and control of the plurality of optical signals.

9. A method for solving Ising problems using an electro-optic Coherent Ising Machine (CIM), the method comprising:
receiving, by a system via a Multi-Path Interferometer (MPI), a plurality of optical signals corresponding to a plurality of dynamic spin variables of one or more ising problems, wherein the dynamic spin variables comprise a coefficient matrix comprising coefficients in N rows and N columns representing an ising model, and wherein each of the dynamic spin variables corresponds to an electric field of the plurality of optical signals;
executing, by the system via the MPI, a linear operation corresponding to at least one of each of spin interactions and each of variables interactions in an Ising model, by combining a plurality of dynamic spin variables;
measuring, by the system via a high-bandwidth photodiode associated with a plurality of Balanced Homodyne Detectors (BHDs), an optical electric field value of the plurality of optical signals;
converting, by the system via a Transimpedance Amplifier (TIA) associated with the plurality of BHDs, the electrical current to an electrical voltage corresponding to an electrical field value of the plurality of optical signals, plurality of optical signals into electrical output signals comprising an updated plurality of dynamic spin variables;
executing, by the system via a plurality of Mach-Zehnder interferometers (MZIs), the plurality of MZIs using the electrical output signals from a corresponding BHD, and controlling an optical electric field value of the corresponding dynamic spin variable at each of the one or more input nodes of the MPI;
holding, by the system via a plurality of Sampling Capacitors (SCs) network, a previously sampled output, and alternating, using a clock signal, one or more sampling phases and one or more holding phases for discrete-time evolution of the dynamic spin variables, wherein the evolution of the dynamic spin variables comprises iteratively updating spin values of the plurality of dynamic spin variables until each spin value converges to at least one of a high spin value and a low spin value;
generating, by the system via a laser source, the plurality of optical signals, wherein the plurality of optical signals are split by a coupler, into at least two sets of 1:N beam-splitter networks; and
outputting, by the system via an output circuitry, the evolution of the dynamic spin variables comprising a solution to the one or more Ising problems.

10. The method as claimed in claim 9, further comprises:
dividing, by the system via the plurality of MZIs, the plurality of optical signals into at least two optical paths;
modulating, by the system via at least two Electro-Optic Modulators (EOMs), a phase of the divided plurality of optical signals, based on an external electrical input; and
combining, by the system via the plurality of MZIs, the modulated plurality of optical signals, and generating a modulated optical output signal.

11. The method as claimed in claim 10, further comprises:
receiving and amplifying, by the system via a plurality of buffer amplifiers, the modulated optical output signal;
receiving, by the system via the plurality of BHDs, the modulated optical output signal and a local oscillator (LO) signal corresponding to the local oscillator reference signals, wherein the optical beam splitter is configured to generate a first optical output signal and a second optical output signal;
converting, by the system via at least two photodiodes, the optical signals into electric current signals;
converting, by the system via the TIA, the difference in electric current signals from the at least two photodiodes into voltage signals an discrete-time evolution electronic voltage signal corresponding to the dynamic spin variables;
segregating and filtering, by the system via a plurality of capacitor networks, the electric current signals into at least one of a hold signal and a sampling signal; and
controlling, by the system via a plurality of switches, a charging and a discharging of the plurality of capacitor networks for sampling and holding the electric current signals into at least one of the hold signal and the sampling signal.

12. The method as claimed in claim 11, further comprises:
generating, by the system via the TIA, a differential output for a subsequent sampling through a sampling capacitor network and control of the plurality of optical signals.

13. The method as claimed in claim 9, further comprises:
receiving, by the system via each of the MZI, the electrical output signals from the plurality of BHDs; and
executing, by the system via each of the MZI, a non-linear operation on the electrical output signals to modulate an optical electric field value of the dynamic spin variables at the one or more input nodes of the MPI.

14. The method as claimed in claim 9 further comprises:
performing, by the system via the MPI, a parallel matrix-vector multiplication with an interaction matrix to compute a weighted addition of the spin interactions.

15. The method as claimed in claim 9 further comprises:
outputting, by the system via a first 1:N beam-splitter network of the laser source, one or more N optical inputs, wherein each of the one or more N optical inputs is transmitted to a corresponding MZI; and
outputting, by the system via a second 1:N beam-splitter network of the laser source, one or more N local oscillator reference signals, wherein each of the one or more N local oscillator reference signals is transmitted to a corresponding BHD.

16. The method as claimed in claim 9, wherein the one or more ising problems comprise at least one of an optimization problem, a graph problem, and a combinatorial optimization problem.

17. The method as claimed in claim 9, wherein the electric field of the plurality of optical signals is modulated based on a periodic sinusoidal transfer function implemented by electrical-to-optical transfer characteristics of the plurality of MZIs and imparts a sinusoidal non-linearity to an optical electric field value of the dynamic spin variables.

18. The method as claimed in claim 9, wherein the iteratively updating the spin values of the plurality of dynamic spin variables is based on a gain-dissipative dynamic technique, wherein the plurality of MZIs uses a coupling term to generate an Ising Hamiltonian computation, wherein the coupling term controls the interaction strength between the dynamic spin variables, uses a bifurcation parameter controlling the gain-dissipative dynamics of the system, wherein the bifurcation parameter governs a convergence behaviour of the system.
